(19) United States
(12) Patent Application Publication
(10) Pub. No.: US 2024/0329970 A1
(43) Pub. Date: Oct. 3, 2024

(54) CONTROL DEVICE AND VEHICLE

(71) Applicant: HONDA MOTOR CO., LTD., Tokyo (JP)

(72) Inventors: Kazumu SUZUKI, Tokyo (JP); Kazune HASEGAWA, Tokyo (JP); Kai MOTOYAMA, Tokyo (JP); Shota HOSHAKU, Tokyo (JP); Tomoaki MASAKAWA, Tokyo (JP); Taira IKEDAGAKI, Tokyo (JP); Tadahiko KANOH, Tokyo (JP); Kenji SUGIYAMA, Tokyo (JP)

(21) Appl. No.: 18/583,062

(22) Filed: Feb. 21, 2024

(30) Foreign Application Priority Data
Mar. 31, 2023 (JP) 2023-059050

(51) Int. Cl. G06F 8/65; B60W 50/04; H04W 4/40

(52) U.S. Cl. CPC G06F 8/65; B60W 50/04; H04W 4/40; B60W 2756/10

(57) ABSTRACT

A vehicle control device having a driving assistance function, includes: a communication unit configured to communicate with a server; a controller configured to control the vehicle based on a validated vehicle function; and a sensor configured to detect a traveling state of the vehicle. When the communication unit receives update information for invalidating the vehicle function from the server while the vehicle is traveling, the controller prohibits invalidation of the validated vehicle function.

### CROSS-REFERENCE TO RELATED APPLICATION(S)

This application claims priority to and the benefit of Japanese Patent Application No. 2023-059050 filed on Mar. 31, 2023, the entire disclosure of which is incorporated herein by reference.

### BACKGROUND OF THE INVENTION

### Field of the Invention

The present invention relates to a control device and a vehicle.

### Description of the Related Art

In recent years, efforts to provide access to sustainable transportation systems in consideration of vulnerable people among traffic participants have been gaining momentum. In order to realize this, research and development for further improving traffic safety and convenience is focused on research and development regarding driving assistance technology. A business of enabling purchase of a desired vehicle function (for example, a driving assistance function or the like) by over-the-air (OTA) update after purchase of a vehicle and updating the vehicle so that a user can execute the purchased function has been studied. These vehicle functions are not only validated by update, but may also be invalidated by update, for example, when a trial period has elapsed (Japanese Patent Laid-Open No. 2022-57228). Therefore, it is conceivable that information in which valid/invalid information of a vehicle function be associated with user information is managed by a server, and when the valid/invalid information is updated, update information be transmitted from the server to the vehicle to validate or invalidate the function of the vehicle.

Incidentally, when the valid/invalid information managed by the server is switched from valid to invalid due to the lapse of the trial period after the start of traveling of the vehicle, update information for invalidating the vehicle function is transmitted to the vehicle, and there may be a case where it is not preferable to immediately invalidate the vehicle function during traveling according to the update information.

In order to solve the above problems, an object of the present invention is to provide a control technique capable of prohibiting update of a vehicle function during traveling. In addition, such an object contributes to development of the sustainable transportation system.

### SUMMARY OF THE INVENTION

According to one aspect of the present invention, there is provided a vehicle control device having a driving assistance function, comprising: a communication unit configured to communicate with a server; a controller configured to control the vehicle based on a validated vehicle function; and a sensor configured to detect a traveling state of the vehicle, wherein, when the communication unit receives update information for invalidating the vehicle function from the server while the vehicle is traveling, the controller prohibits invalidation of the validated vehicle function.

### BRIEF DESCRIPTION OF THE DRAWINGS

FIG. 1 is a diagram illustrating a basic configuration of a vehicle control system;

FIG. 2 is a block diagram illustrating a basic configuration of an information terminal device;

FIG. 3A is a block diagram illustrating a basic configuration of a server;

FIG. 3B is a diagram illustrating various applications stored in a server;

FIG. 4 is a block diagram of a vehicle and a control device according to an embodiment;

FIG. 5 is a diagram illustrating a state transition in a driving assistance function;

FIG. 6 is a block diagram illustrating a basic configuration of a control device;

FIG. 7 is a diagram illustrating various applications stored in a storage unit;

FIG. 8 is a diagram for explaining a flow of processing of the control device at the time of activation of a vehicle V;

FIG. 9 is a diagram for explaining a flow of processing of the control device when the vehicle V travels; and

FIG. 10 is a diagram for explaining a flow of processing of the control device when the vehicle V travels.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### (Configuration of Vehicle Control System)

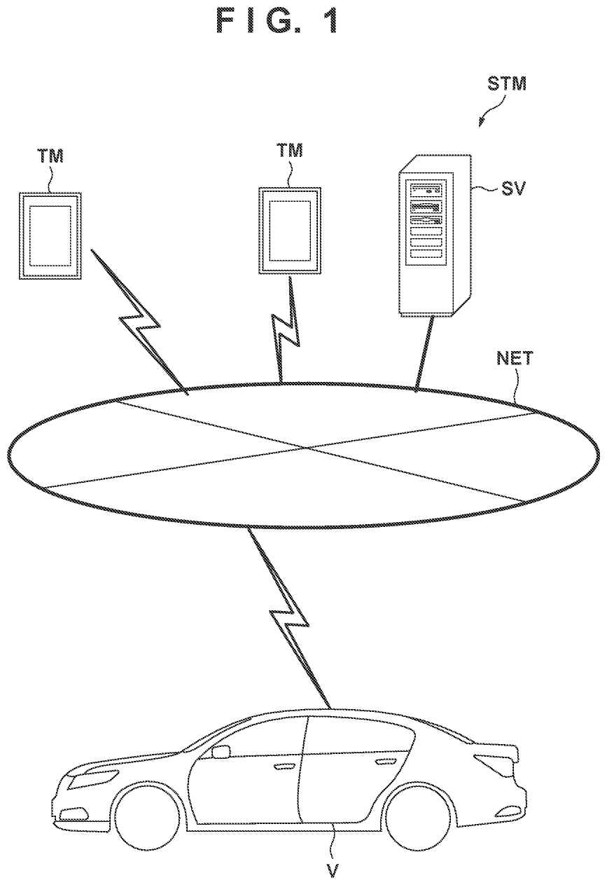

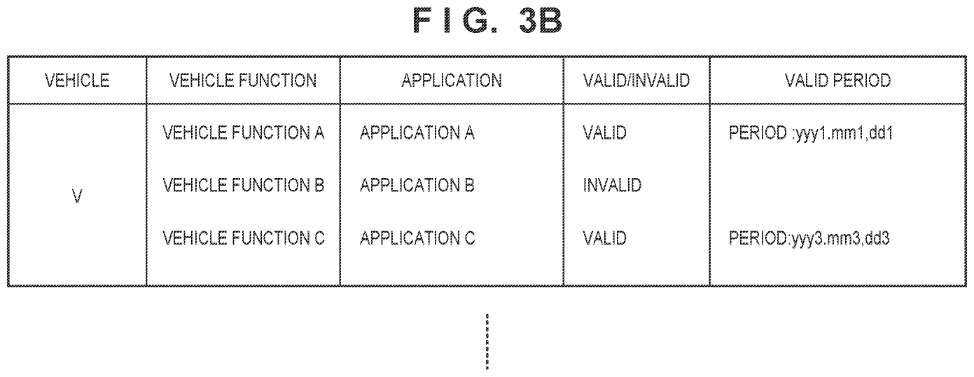

FIG. 1 is a diagram illustrating a basic configuration of a vehicle control system STM, and the vehicle control system STM includes a vehicle V, an information terminal device TM, and a server SV. The information terminal device TM can display (provide) content for purchasing a vehicle function of the vehicle V on the display unit. In addition, the server SV can communicate with the vehicle V and the information terminal device TM, and holds information between the vehicle V and the user in an internal information holding unit (SV1 in FIG. 3A). The information holding unit SV1 of the server SV may be arranged as a storage device on the network (cloud) NET.

### (Configuration of Information Terminal Device TM)

The information terminal device TM can be configured as, for example, a mobile terminal (tablet PC, smartphone, or the like) possessed by the user or an information terminal arranged in a base (dealer) that sells or maintains the vehicle V.

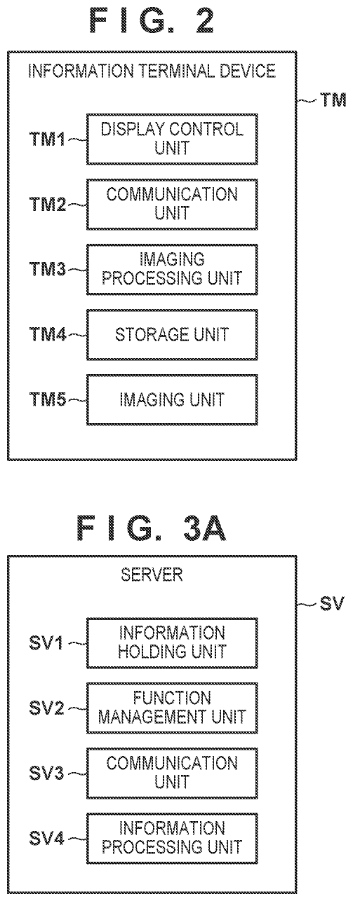

FIG. 2 is a block diagram illustrating a basic configuration of the information terminal device TM.

A display control unit TM1 can also cause the display unit to display content for purchasing a vehicle function (various functions related to vehicle control) of the vehicle V, or cause the display unit of the information terminal device TM to display content for explaining the vehicle function and instructing an operation method. The user can experience explanation of various vehicle functions of the vehicle V, an operation method, and the like by viewing an instruction (tutorial) that explains the vehicle function provided by the content.

The display control unit TM1 can cause the display unit to display an operation input unit (icon) for inputting an instruction to purchase the vehicle function or experience (trial) the vehicle function for free, and the user can purchase the vehicle function or experience the vehicle function for a certain period of time for free by inputting the instruction from the operation input unit (icon). A communication unit TM2 transmits the instruction input from the operation input unit (icon) to the server SV.

The information terminal device TM may include an imaging processing unit TM3 and an imaging unit TM5 as functions for authenticating the user. The imaging unit TM5 (for example, the internal camera) captures an image of the user when the user inputs an instruction from the operation input unit (icon), and the imaging processing unit TM3 processes the image captured by the imaging unit TM5. The imaging processing unit TM3 can acquire image information (for example, a facial image) of the user by processing the image captured by the imaging unit TM5. The image information of the user is stored in a storage unit TM4.

In a case where the image information of the user is requested from the server SV, the communication unit TM2 can transmit the image information of the user stored in the storage unit TM4 to the server SV. In addition, when transmitting the instruction input from the operation input unit (icon) to the server SV, the communication unit TM2 may transmit the image information of the user to the server SV together with the instruction.

The information terminal device TM can be configured as a terminal device of a user (tablet PC, smartphone, or the like) or a terminal device arranged in a base (dealer) that sells or maintains the vehicle V.

Regarding the function purchase by the user, for example, the vehicle function can be purchased at the time of vehicle purchase (when purchasing a new car or purchasing a used car) or after the vehicle purchase. As a purchase format, for example, the vehicle function may be collectively purchased, or the vehicle function may be purchased in a subscription format in units of a predetermined period. In addition, trial purchase is also possible in which the vehicle function can be experienced for a certain period of time for free. The user can select a purchase format and input an instruction by an operation from an operation input unit (icon). The communication unit TM2 transmits an input purchase instruction to the server SV. The communication unit TM2 transmits identification information for identifying the purchase instruction (package, free trial, subscription format, or the like) to the server SV.

In addition, the user can instruct cancellation of the vehicle function by an operation from the operation input unit (icon), and the communication unit TM2 transmits the inputted cancellation instruction to the server SV.

### (Configuration of Server SV)

FIG. 3A is a block diagram illustrating a basic configuration of the server SV. The server SV includes, as functional configurations, an information holding unit SV1 that holds information associating the vehicle V with the user, and a function management unit SV2 that validates or invalidates the vehicle function on the basis of information transmitted from the information terminal device TM.

The information holding unit SV1 can hold log information transmitted from the information terminal device TM and the image information of the user for authentication.

The function management unit SV2 generates update information for validating the vehicle function on the basis of the purchase instruction transmitted from the information terminal device TM. In an initial state before purchasing the vehicle function, the vehicle function is invalidated, and the vehicle function can be validated on the basis of the update information. The update information for validating the vehicle function includes a period (valid period) from the start to the end of the validation. As the period to be validated, different periods are set depending on the purchase format.

FIG. 3B is a diagram illustrating various applications A to C stored in the function management unit SV2 of the server SV, and the applications A to C are applications corresponding to the vehicle functions A to C, respectively. The update information includes a period (valid period) from the start to the end of the validation, and the valid period can be set to different periods depending on the purchase format of the user. The valid/invalid states of the vehicle functions A to C are managed for each vehicle in which the applications A to C are downloaded, an information processing unit SV4 generates update information for setting the valid state to the invalid state for the application for which the valid period has elapsed, and a communication unit SV3 transmits the generated update information to the vehicle V.

The communication unit SV3 transmits the update information generated by the function management unit SV2 to the vehicle V.

The information processing unit SV4 of the server SV can perform various types of information processing on the basis of information acquired from the information terminal device TM or a controller 1 (control device) of the vehicle V. When the cancellation instruction of the vehicle function is received from the information terminal device TM, the image information of the user received together with the cancellation instruction can be compared with the image information of the user held in the information holding unit SV1 to authenticate the user.

When receiving the cancellation instruction from the authenticated user, the function management unit SV2 generates update information for invalidating the validated vehicle function, and the communication unit SV3 transmits the update information generated by the function management unit SV2 to the vehicle V. When the cancellation instruction is received from the authenticated user even in the middle of the valid period, the function management unit SV2 generates update information for invalidating the vehicle function, and the communication unit SV3 transmits the update information generated by the function management unit SV2 to the vehicle V.

### (Configuration of Vehicle Control Device)

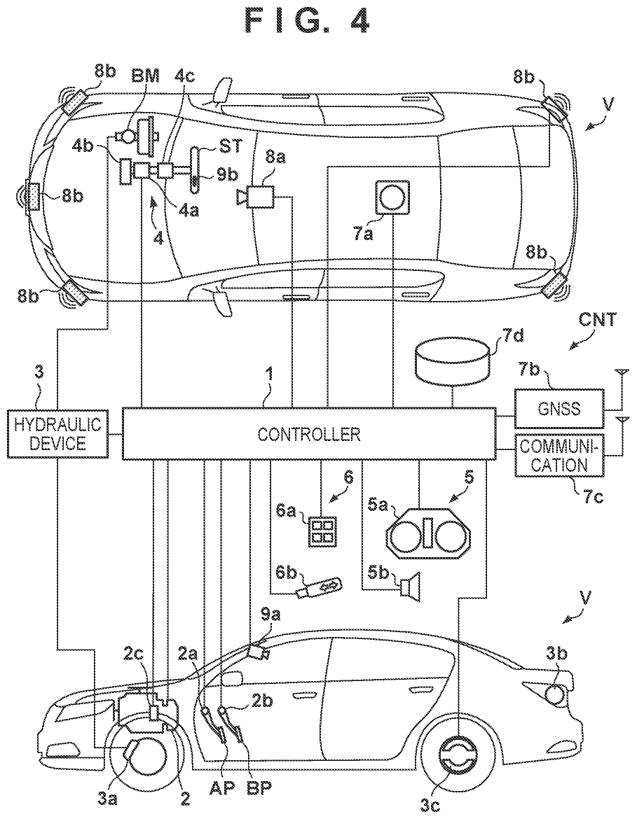

FIG. 4 is a block diagram of the vehicle V and the controller 1 (control device) of the vehicle V according to the embodiment. In FIG. 4, an outline of the vehicle V is illustrated by a plan view and a side view. The vehicle V of the present embodiment is a sedan-type four-wheeled passenger vehicle as an example, but the vehicle V is not limited to a four-wheeled passenger vehicle, and may be a straddle type vehicle (two-wheeled vehicle or three-wheeled vehicle) or a large vehicle such as a truck or a bus.

The controller 1 is an electronic circuit that executes control of the vehicle V including driving assistance. The controller 1 includes a plurality of electronic control units (ECU) includes a processor represented by a central processing unit (CPU), a storage unit such as a semiconductor memory, an interface with an external device, and the like. The storage unit stores programs executed by the processor, data used for processing by the processor, and the like. The interface includes an input and output interface, and a communication interface. Alternatively, each ECU may include a plurality of processors, a plurality of storage units, and a plurality of interfaces.

The controller 1 controls driving (acceleration) of the vehicle V by controlling a power unit (power plant) 2. The power unit 2 is a travel driving unit that outputs driving force for rotating driving wheels of the vehicle V, and can include an internal combustion engine, a motor, and an automatic transmission. The motor can be used as a drive source for accelerating the vehicle V, and can also be used as a generator at the time of deceleration or the like (regenerative braking).

In the case of the present embodiment, the controller 1 controls the output of the internal combustion engine or the motor or switches a gear ratio of the automatic transmission in accordance with a driving operation of a driver or vehicle speed detected by an operation detection sensor 2a provided on an accelerator pedal AP or an operation detection sensor 2b provided on a brake pedal BP. Note that the automatic transmission includes a rotation speed sensor 2c, which detects the rotation speed of an output shaft of the automatic transmission, as a sensor that detects a traveling state of the vehicle V. It is possible to calculate the vehicle speed of the vehicle V from a result of detection by the rotation speed sensor 2c.

The controller 1 controls braking (deceleration) of the vehicle V by controlling a hydraulic device 3. The driver's braking operation on the brake pedal BP is converted into hydraulic pressure in a brake master cylinder BM and transmitted to the hydraulic device 3. The hydraulic device 3 is an actuator capable of controlling the hydraulic pressure of the hydraulic oil supplied to a brake device 3a (for example, a disc brake device) provided on each of the four wheels, based on the hydraulic pressure transmitted from the brake master cylinder BM.

The controller 1 can control braking of the vehicle V by performing drive control of an electromagnetic valve or the like included in the hydraulic device 3. The controller 1 can also configure an electric servo brake system by controlling the distribution of the braking force by the brake device 3a and the braking force by the regenerative braking of the motor included in the power unit 2. The controller 1 may turn on a brake lamp 3b at the time of braking.

The controller 1 controls the steering of the vehicle V by controlling an electric power steering device 4. The electric power steering device 4 includes a mechanism that steers a front wheel according to the driver's driving operation (steering operation) on a steering wheel ST. The electric power steering device 4 includes a drive unit 4a including a motor that exerts driving force (referred to as steering assist torque, in some cases) for assisting the steering operation or automatically steering the front wheels, a steering angle sensor 4b, a torque sensor 4c that detects steering torque (referred to as steering load torque to be distinguished from the steering assist torque) applied by the driver, and the like.

The controller 1 controls an electric parking brake device 3c provided on the rear wheel. The electric parking brake device 3c includes a mechanism for locking the rear wheel. The controller 1 can control locking and unlocking of the rear wheel by the electric parking brake device 3c.

The controller 1 controls the information output device 5 that notifies information to the inside of the vehicle. The information output device 5 includes, for example, an information display device 5a that notifies (displays) the driver of information by an image, and/or an audio output device 5b that notifies the driver of information by a voice. The information display device 5a can be provided on, for example, an instrument panel or a steering wheel ST. The information display device 5a may be a head-up display. The information output device 5 may notify the occupant of information by vibration or light. In addition, the controller 1 receives an instruction input from an occupant (for example, a driver) via an input device 6. The input device 6 is disposed at a position operable by the driver, and includes, for example, a switch group 6a with which the driver instructs the vehicle V and/or a blinker lever 6b for operating a direction indicator (blinker).

The controller 1 recognizes and determines a current position and a course (posture) of the vehicle V. In the case of the present embodiment, the vehicle V is provided with a gyro sensor 7a, a global navigation satellite system (GNSS) sensor 7b, and a communication unit 7c. The gyro sensor 7a detects rotational motion (yaw rate) of the vehicle V. The GNSS sensor 7b detects a current position of the vehicle V. In addition, the communication unit 7c performs wireless communication with a server that provides map information and traffic information, and obtains these pieces of information. In the case of the present embodiment, the controller 1 determines the course of the vehicle V based on the detection results of the gyro sensor 7a and the GNSS sensor 7b, sequentially acquires highly accurate map information regarding the course from the server via the communication unit 7c, and stores the map information in a database 7d (storage unit). Note that the vehicle V may be provided with a sensor for detecting the state of the vehicle V, such as a speed sensor for detecting the speed of the vehicle V or an acceleration sensor for detecting the acceleration of the vehicle V.

The controller 1 performs driving assistance of the vehicle V based on detection results of various detection units provided in the vehicle V. The vehicle V is provided with surrounding detection units 8a to 8b, which are external sensors that detect the outside (surrounding situation) of the vehicle V, and in-vehicle detection units 9a to 9b, which are in-vehicle sensors that detect the situation (the state of the driver) inside the vehicle. The controller 1 can grasp the surrounding situation of the vehicle V based on the detection results of the surrounding detection units 8a to 8b, and execute driving assistance according to the surrounding situation. In addition, the controller 1 can determine whether the driver is performing a predetermined operation obligation imposed on the driver when executing the driving assistance based on the detection results of the in-vehicle detection units 9a to 9b.

The surrounding detection unit 8a is an imaging device (hereinafter, may be referred to as a front camera 8a) that captures an image of the front of the vehicle V, and is attached to the vehicle interior side of the windshield at the front of the roof of the vehicle V, for example. The controller 1 can extract a contour of a target or a lane marking (such as a white line) on a road by analyzing an image captured by the front camera 8a.

The surrounding detection unit 8b is a millimeter wave radar (hereinafter, it may be referred to as a radar 8b), detects a target around the vehicle V using radio waves, and detects (measures) a distance to the target and a direction (azimuth) of the target with respect to the vehicle V. In the example illustrated in FIG. 4, five radars 8b are provided, one at the center of the front portion of the vehicle V, one at each of the left and right corner portions of the front portion, and one at each of the left and right corner portions of the rear portion.

Note that the surrounding detection unit provided in the vehicle Vis not limited to the above configuration, and the number of cameras and the number of radars may be changed, or a light detection and ranging (LiDAR) for detecting a target around the vehicle V may be provided.

The in-vehicle detection unit 9a is an imaging device (hereinafter, may be referred to as an in-vehicle camera 9a) that captures an image of the inside of the vehicle, and is attached to, for example, the vehicle interior side at the front of the roof of the vehicle V. In the case of the present embodiment, the in-vehicle camera 9a is a driver monitor camera that captures an image of the driver (for example, eyes and a face of the driver). The controller 1 can determine the direction of the line of sight and the face of the driver by analyzing an image (a facial image of the driver) captured by the in-vehicle camera 9a.

The in-vehicle detection unit 9b is a grip sensor (hereinafter, it may be referred to as a grip sensor 9b) that detects grip of the steering wheel ST by the driver, and is provided in at least a part of the steering wheel ST, for example. As the in-vehicle detection unit, the torque sensor 4c that detects the steering torque of the driver may be used.

Examples of the driving assistance of the vehicle V include acceleration/deceleration assistance, lane keeping assistance, and lane change assistance. The acceleration/deceleration assistance is driving assistance (adaptive cruise control (ACC)) that controls acceleration/deceleration of the vehicle V within a predetermined vehicle speed while maintaining an inter-vehicle distance from a preceding vehicle by controlling the power unit 2 and the hydraulic device 3. The lane keeping assistance is driving assistance (lane keeping assist system (LKAS)) that controls the electric power steering device 4 to keep the vehicle V inside the lane. The lane change assistance is driving assistance (advanced lane change (ALC), active lane change assist (ALCA)) for changing the traveling lane of the vehicle V to the adjacent lane by controlling the electric power steering device 4. In addition, the driving assistance executed by the controller 1 may include a collision mitigation brake system, an ABS function, traction control, and/or posture control of the vehicle V for assisting collision avoidance with a target (for example, a pedestrian, another vehicle, or an obstacle) on the road by controlling the hydraulic device 3.

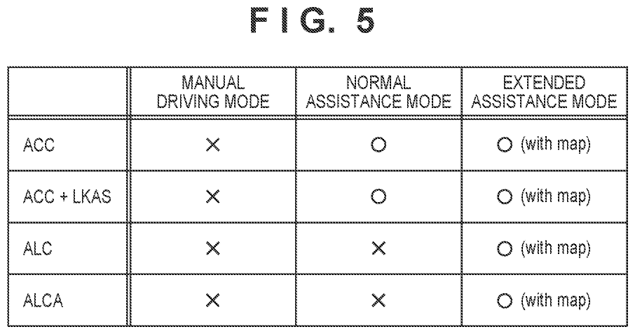

The driving assistance (acceleration/deceleration assistance, lane keeping assistance, and lane change assistance) of the vehicle V is performed in a plurality of modes including a manual driving mode, a normal assistance mode, and an extended assistance mode. FIG. 5 illustrates driving assistance performed in each of the manual driving mode, the normal driving mode, and the extended driving mode of the present embodiment. In the manual driving mode, the acceleration/deceleration assistance, lane keeping assistance, and lane change assistance are not executed, and manual driving of the vehicle V is performed by the driver.

In the manual driving mode, when an instruction to set the acceleration/deceleration assistance (ACC) is input by the driver via the input device 6 (for example, the switch group 6a), the acceleration/deceleration assistance is started, and the manual driving mode is shifted to the normal assistance mode. In the normal assistance mode, the lane keeping assistance (LKAS) can be executed in addition to the acceleration/deceleration assistance. The lane keeping assistance is started when an instruction input for setting the lane keeping assistance is made by the driver via the input device 6 (for example, the switch group 6a) during the setting of the acceleration/deceleration assistance. The acceleration/deceleration assistance and the lane keeping assistance are terminated when an instruction to cancel the setting is input by the driver via the input device 6 (for example, the switch group 6a).

In the normal assistance mode, the driver is required to perform predetermined operation obligations such as surrounding monitoring and steering wheel gripping. When it is determined that the driver does not perform the predetermined operation obligation on the basis of the detection result of the in-vehicle detection unit 9b, a notification for prompting the driver to perform the predetermined operation obligation is made via the information output device 5.

When traveling on a specific road is started during execution of the normal assistance mode, highly accurate map information is acquired by the communication unit 7c. Then, when matching between the highly accurate map information and the image captured by the front camera 8a is successful, the normal assistance mode automatically transitions to the extended assistance mode. The specific road is a road that provides highly accurate map information, and examples thereof include an expressway and an automobile exclusive road. The highly accurate map information includes, in addition to normal information such as a route and a position of the specific road, information related to a detailed shape of the specific road such as presence or absence and a curvature of a curve, an increase or decrease in a lane, and a gradient of the specific road. When the normal assistance mode is shifted to the extended assistance mode, an information notification device 31 makes a notification indicating that the mode is shifted to the extended assistance mode, for example, by changing a light emission color or turning on or off the light of the information notification device 31 provided in the steering wheel ST.

In the extended assistance mode, acceleration/deceleration assistance (and lane keeping assistance) in cooperation with highly accurate map information is performed. For example, based on the highly accurate map information, the controller 1 can perform more advanced acceleration/deceleration assistance than that in the normal assistance mode, such as decelerating the vehicle V before a curve or before a point where lanes decrease, or adjusting the speed of the vehicle V according to a curvature of the curve. As in the normal assistance mode, the driver is required to perform predetermined operation obligations such as surrounding monitoring and steering wheel gripping in the extended assistance mode. When it is determined that the driver does not perform the predetermined operation obligation on the basis of the detection result of the in-vehicle detection unit 9b, a notification for prompting the driver to perform the predetermined operation obligation is made via the information output device 5.

In addition, in the extended assistance mode, the lane change assistance can be further executed. In the case of the present embodiment, the lane change assistance includes system-initiated lane change assistance (advanced lane change (ALC)) that automatically changes the lane based on the determination by the controller 1, and driver-initiated lane change assistance (active lane change assist (ALCA)) that automatically changes the lane based on an instruction input from the driver. Note that, in both the system-initiated lane change assistance (ALC) and the driver-initiated lane change assistance (ALCA), the driver is required to perform predetermined operation obligations such as surrounding monitoring and steering wheel gripping when the lane change assistance is performed.

The system-based lane change assistance (ALC) is started when an instruction input for setting the ALC in the extended assistance mode is performed by the driver via the input device 6 (for example, the switch group 6a). During the ALC setting, the controller 1 sequentially determines whether it is necessary to execute a lane change in order to arrive at a destination set in advance by the driver on the basis of highly accurate map information (information such as increase/decrease or branching of a lane), and automatically performs the lane change when determining that it is necessary to execute the lane change. During the ALC setting, one or more lane changes can be executed according to the determination of the controller 1. The ALC ends when the vehicle arrives at the destination or when the specific road ends. The ALC may be ended in a case where an instruction input to cancel the setting is performed by the driver via the input device 6 (for example, the switch group 6a).

The driver-initiated lane change (ALCA) is performed once in response to an instruction input by the driver, and is performed when an instruction to instruct execution of ALCA in the extended assistance mode is input by the driver via the input device 6 (for example, an indicator stalk 6b). In the ALCA, a driver can input an instruction of a direction in which a lane change is to be performed via the input device 6 (indicator stalk 6b), and the controller 1 automatically performs a lane change to an adjacent lane in the direction in which the instruction is input by the driver. The ALCA can also be performed during the setting of the system-initiated lane change assistance (ALC).

### (Configuration of Control Device)

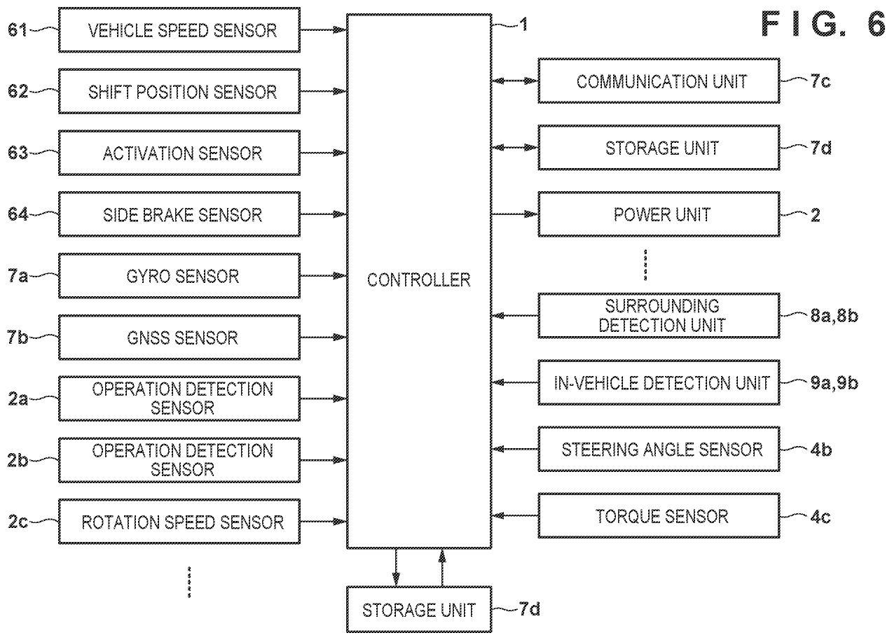

FIG. 6 is a block diagram illustrating a basic configuration of the controller 1 (control device). As illustrated in FIG. 6, detection signals of various sensors are input to the controller 1. A vehicle speed sensor 61 detects the vehicle speed of the vehicle V. A shift position sensor 62 detects a shift position of the vehicle V. An activation sensor 63 detects start or end of activation of the vehicle V. The activation sensor 63 detects start or end of activation of the vehicle V based on, for example, an ignition on (IG_ON) signal or an ignition off (IG_OFF) signal of the ignition device.

Note that the various sensors are not limited to the sensors in FIGS. 5 and 6, and the vehicle V is provided with various sensors, and the controller 1 can control the vehicle V by generating a control signal on the basis of detection signals of the various sensors.

The communication unit 7c can communicate with the server SV or the information terminal device TM. The storage unit 7d stores various applications related to vehicle functions. In the initial state, the vehicle function is invalidated, and when update information is received from the server SV via the communication unit 7c, the vehicle function is validated on the basis of the update information. By validating the vehicle function, an application corresponding to the vehicle function can be executed, and driving assistance by the application corresponding to the vehicle function can be provided in the vehicle V.

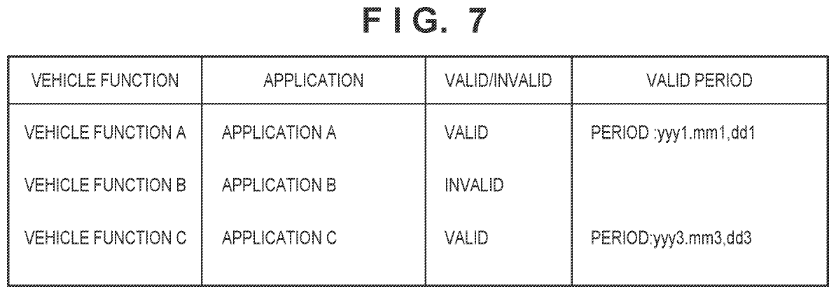

FIG. 7 is a diagram illustrating various applications A to C stored in the storage unit 7d, and the applications A to C are applications corresponding to the vehicle functions A to C. The update information includes a period (valid period) from the start to the end of the validation, and when the vehicle function is validated in the vehicle V, the valid period is set. As the period to be validated, different periods can be set depending on the purchase format of the user.

### (Process: Before Start of Traveling)

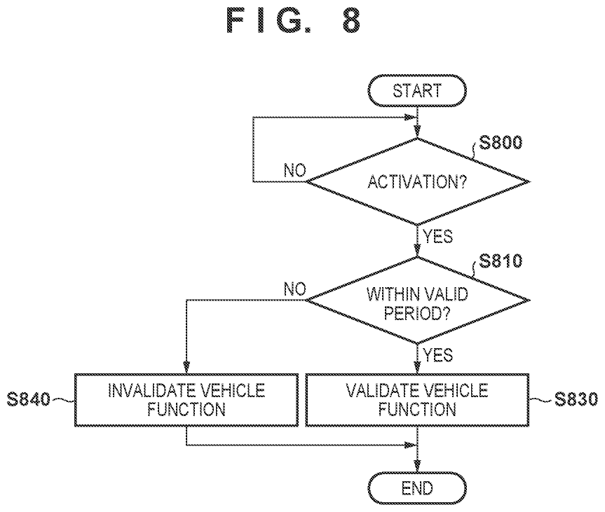

FIG. 8 is a diagram for explaining a flow of processing of the controller 1 (control device) before the start of traveling of the vehicle V. In S800, the controller 1 determines start or end of activation of the vehicle V based on the detection result of the activation sensor 63. When the activation is ended (NO in S800), the processing returns to the determination of S800, and the similar processing is repeated. In the determination processing of S800, when the activation is started (YES in S800), the processing proceeds to S810.

In S810, the controller 1 determines whether the vehicle functions A to C set in the storage unit 7d are within the valid period. When the vehicle function is outside the valid period (NO in S810), the controller 1 invalidates the vehicle function outside the valid period (S840). The invalid state of the vehicle function is maintained. On the other hand, in the determination process of S810, when the current time is within the valid period (YES in S810), the controller 1 validates the vehicle function within the valid period (S830). The controller 1 can control the vehicle V based on the validated vehicle function.

### (Process: After Start of Traveling)

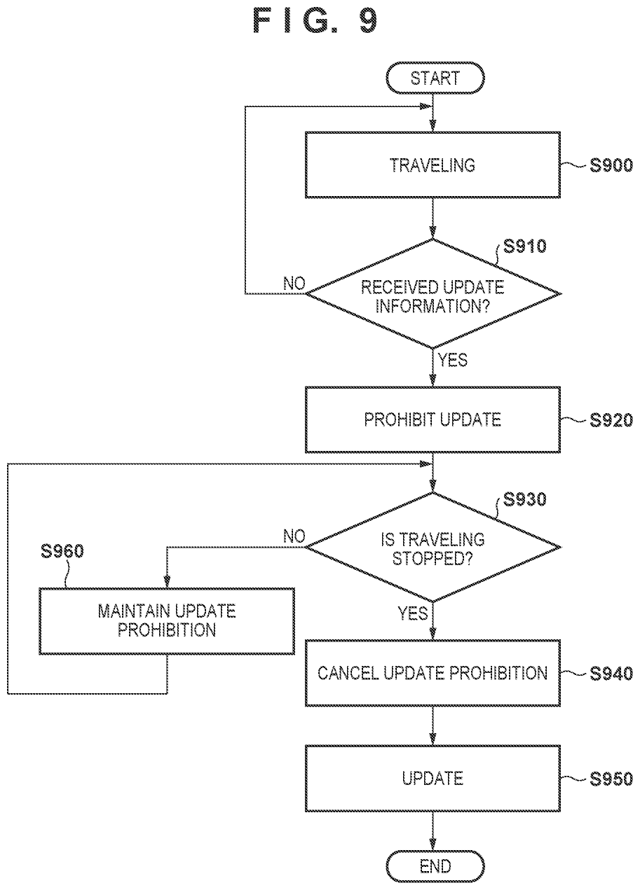

FIG. 9 is a diagram for explaining a flow of processing of the controller 1 (control device) when the vehicle V travels (after the start of traveling). In S900, the vehicle Vis in a traveling state. In S910, the controller 1 determines whether or not update information has been received from the server SV while the vehicle Vis traveling. When the update information is not received (NO in S910), the controller 1 returns the processing to S900 and repeats the same processing. On the other hand, when the update information is received from the server SV while the vehicle Vis traveling in S910 (YES in S910), the process proceeds to S920.

In S920, the controller 1 prohibits update (update of validity/invalidity) of the vehicle function. Even when receiving the update information, the controller 1 maintains the valid/invalid state at the time of starting the vehicle while the vehicle Vis traveling. That is, the state in which the function of the predetermined application is provided by the activation is maintained while the vehicle V is traveling.

In S930, the controller 1 determines whether the vehicle Vis in a traveling stop state. The controller 1 can make a determination by at least one of or a combination of various sensors such as a vehicle speed sensor 61, a shift position sensor 62, an activation sensor 63, and a side brake sensor 64.

For example, the controller 1 can determine whether the vehicle Vis in a traveling state or a stopped state based on a detection signal for detecting a state in which the vehicle speed of the vehicle V becomes 0 by the vehicle speed sensor 61. Alternatively, the controller 1 can determine whether the vehicle Vis in the traveling state or the stopped state based on a detection signal for detecting a state in which the shift position is shifted to the parking range (P) by the shift position sensor 62.

Alternatively, the controller 1 can determine whether the vehicle Vis in the traveling state or the stopped state based on a detection signal for detecting whether the vehicle Vis in the activation state or the activation stop state by the activation sensor 63. Alternatively, the controller 1 can determine whether the vehicle V is in the traveling state or the stopped state based on a detection signal for detecting whether the side brake of the vehicle Vis operated by the side brake sensor 64.

That is, when at least one of a state in which the vehicle speed becomes zero, a state in which the shift position shifts to the parking range, a state in which the start and stop of the vehicle V are detected, and a state in which the operation of the parking brake is detected is detected, the controller 1 can determine that the end of traveling of the vehicle V is detected. Note that the various sensors for determining whether the vehicle V is in the traveling stop state are not limited to the vehicle speed sensor 61, the shift position sensor 62, the activation sensor 63, and the side brake sensor 64, and can be determined by at least one of the various sensors illustrated in FIG. 6 or a combination thereof.

In the determination process of S930, when the traveling is not stopped (NO in S930), the process proceeds to S960, and in S960, the controller 1 maintains the update prohibition state and returns the process to S930.

In the determination processing of S930, when the traveling is stopped (YES in S930), the processing proceeds to S940, and in S940, the controller 1 cancels the update prohibition and advances the processing to S950.

In S950, the controller 1 updates the validated/invalidated state of the vehicle function based on the update information received in S910. According to the controller 1 according to the embodiment, it is possible to prohibit the update of the vehicle function during traveling.

### (Modification of Processing)

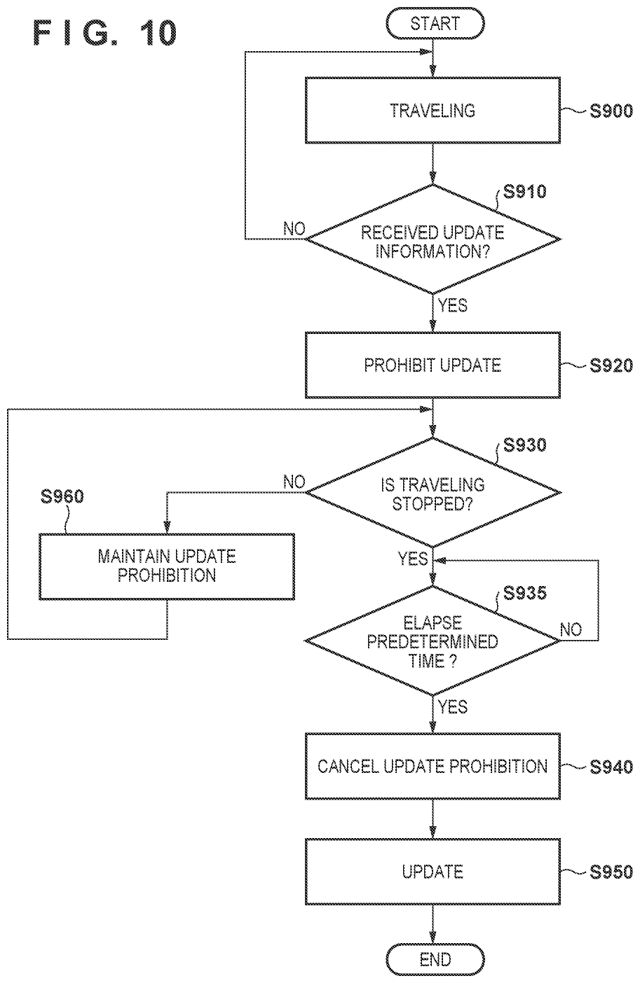

FIG. 10 is a diagram illustrating a modification of the process of FIG. 9, and the process with the same step number as that in FIG. 9 is similar to the process of FIG. 9. FIG. 10 is different from FIG. 9 in that S935 is added.

In S935 of FIG. 10, the controller 1 determines whether a predetermined time has elapsed after the traveling stop is determined (YES in S930). There may be a case where it is temporarily determined that the vehicle is in the traveling stop state due to a minute variation of signals output from various sensors or a temporary operation of the user. In S935 of FIG. 10, after the traveling stop is determined (YES in S930), a standby state is set until a predetermined time elapses (NO in S935), and after the predetermined time elapses (YES in S935), the controller 1 advances the processing to S940. In S940, the controller 1 cancels the update prohibition, and in S950, the controller 1 updates the validated/invalidated state of the vehicle function based on the update information received in S910. The controller 1 prohibits invalidation of the vehicle function until a predetermined time elapses after the end of traveling of the vehicle Vis detected, and cancels the prohibition of invalidation after the predetermined time elapses to invalidate the vehicle function. According to the modification of the process, when the traveling stop state continues for a predetermined time, it is possible to more stably determine the traveling stop state, cancel the prohibition of invalidation, and invalidate the vehicle function.

According to the above embodiment, it is possible to prohibit the update of the vehicle function during traveling.

### Summary of Embodiments

The above embodiment discloses at least the following control device and a vehicle including the control device.

Configuration 1. A vehicle control device having a driving assistance function, includes:
a communication unit (7c) configured to communicate with a server;
a controller (1) configured to control the vehicle based on a validated vehicle function; and
a sensor (61-64) configured to detect a traveling state of the vehicle,
when the communication unit (7c) receives update information for invalidating the vehicle function from the server while the vehicle is traveling,
the controller (1) prohibits invalidation of the validated vehicle function.

According to the control device of the configuration 1, it is possible to prohibit the update of the vehicle function during traveling.

Configuration 2. The controller (1) cancels the prohibition of the invalidation and invalidates the vehicle function when the sensor (61-64) detects the end of traveling of the vehicle.

Configuration 3. The sensor (61-64) includes a vehicle speed sensor (61) that detects a vehicle speed of the vehicle, a shift position sensor (62) that detects a shift position of the vehicle, an activation sensor (63) that detects start of activation of the vehicle or stop of activation of the vehicle, and a side brake sensor (64) that detects whether a side brake of the vehicle is operated, and
when at least one of the states is detected:
a state in which the vehicle speed becomes zero;
a state in which the shift position is shifted to a parking range;
a state in which start and stop of the vehicle are detected; and
a state in which the operation of the side brake is detected,
the controller (1) determines that the end of traveling of the vehicle is detected, cancels the prohibition of the invalidation, and invalidates the vehicle function.

According to the control devices of the configurations 2 and 3, when the end of traveling of the vehicle is detected, it is possible to cancel the prohibition of invalidation and invalidate the vehicle function.

Configuration 4. The controller (1) prohibits invalidation of the vehicle function until a predetermined time elapses after the end of traveling of the vehicle is detected, and cancels the prohibition of the invalidation and invalidates the vehicle function after the predetermined time elapses.

There may be a case where it is determined that the vehicle is in the traveling stop state due to a minute variation of signals output from various sensors or a temporary operation of the user. According to the control device of the configuration 4, when the traveling stop state continues for a predetermined time, it is possible to more stably determine the traveling stop state, cancel the prohibition of invalidation, and invalidate the vehicle function.

Configuration 5. A vehicle (V) includes the control device according to configuration 1.

According to the vehicle of the configuration 5, it is possible to provide the vehicle including the control device that prohibits the update of the vehicle function during traveling.

### Other Embodiments

In the present invention, it is also possible to supply a program for achieving the functions of the above-described embodiments to a system or a control device constituting the system via a network or a storage medium, and one or more processors on a computer of the control device are capable of reading the program and executing processing of the control device.

The invention is not limited to the foregoing embodiments, and various variations/changes are possible within the spirit of the invention.

What is claimed is:

1. A vehicle control device having a driving assistance function, comprising:
a communication unit configured to communicate with a server;
a controller configured to control the vehicle based on a validated vehicle function; and
a sensor configured to detect a traveling state of the vehicle,
wherein, when the communication unit receives update information for invalidating the vehicle function from the server while the vehicle is traveling,
the controller prohibits invalidation of the validated vehicle function.

2. The control device according to claim 1, wherein the controller cancels the prohibition of the invalidation and invalidates the vehicle function when the sensor detects the end of traveling of the vehicle.

3. The control device according to claim 2, wherein the sensor includes a vehicle speed sensor that detects a vehicle speed of the vehicle, a shift position sensor that detects a shift position of the vehicle, an activation sensor that detects start of activation of the vehicle or stop of activation of the vehicle, and a side brake sensor that detects whether a side brake of the vehicle is operated, and
when at least one of the states is detected:
a state in which the vehicle speed becomes zero;
a state in which the shift position is shifted to a parking range;
a state in which start and stop of the vehicle are detected; and
a state in which the operation of the side brake is detected,
the controller determines that the end of traveling of the vehicle is detected, cancels the prohibition of the invalidation, and invalidates the vehicle function.

4. The control device according to claim 2, wherein the controller prohibits invalidation of the vehicle function until a predetermined time elapses after the end of traveling of the vehicle is detected, and cancels the prohibition of the invalidation and invalidates the vehicle function after the predetermined time elapses.

5. A vehicle comprising the control device according to claim 1.
